(19) United States
(12) Patent Application Publication
(10) Pub. No.: US 2021/0222751 A1
(43) Pub. Date: Jul. 22, 2021

(54) SHOCK ABSORBER

(71) Applicant: HITACHI AUTOMOTIVE SYSTEMS, LTD., Ibaraki (JP)

(72) Inventors: Michio HAYAKAWA, Ibaraki (JP); Hiroyasu SATO, Ibaraki (JP); Reiji NAKAGAWA, Ibaraki (JP)

(21) Appl. No.: 17/056,021

(22) PCT Filed: May 20, 2019
(86) PCT No.: PCT/JP2019/019914

§ 371 Date: Nov. 17, 2020

(30) Foreign Application Priority Data
May 21, 2018 (JP) 2018-097304

(51) Int. Cl. F16F 9/36; F16J 15/3232; F16J 15/3276; F16J 15/56

(52) U.S. Cl. CPC F16F 9/368; F16J 15/3232; F16F 2230/30; F16J 15/56; F16J 15/3276

(57) ABSTRACT

On an outer circumferential portion of a piston band, in a natural state before being disposed in a cylinder, a large diameter part is formed on a side close to a distal end portion of a piston rod or on a side far from the distal end portion, a medium diameter part having a diameter smaller than that of the large diameter part is formed on a side far from the distal end portion or on a side close to the distal end portion, and a small diameter part having a diameter smaller than that of the medium diameter part is formed between the large diameter part and the medium diameter part.

### TECHNICAL FIELD

The present invention relates to a shock absorber.

Priority is claimed on Japanese Patent Application No. 2018-097304, filed in Japan on May 21, 2018, the content of which is incorporated herein by reference.

### BACKGROUND ART

As a piston part used in a shock absorber or the like, there is one having a configuration in which a piston ring having an annular protruding part formed thereon is installed on a piston main body (for example, refer to Patent Literature 1).

### CITATION LIST

### Patent Literature

### [Patent Literature 1]

Japanese Unexamined Patent Application, First Publication No. 2002-276808

### SUMMARY OF INVENTION

### Technical Problem

In a shock absorber, a frictional force between a piston and a cylinder changes due to a radial force applied to a piston rod. There has been a demand for increasing a ratio of increase in frictional force to an increase in the radial force.

The present invention provides a shock absorber capable of increasing a ratio of increase in frictional force between a piston and a cylinder to an increase in radial force applied to a piston rod.

### Solution to Problem

According to a first aspect of the present invention, an outer circumferential portion of a piston band, in a natural state before being disposed in a cylinder, includes a large diameter part formed on a side close to a distal end portion of a piston rod, a medium diameter part having a diameter smaller than that of the large diameter part formed on a side far from the distal end portion, and a small diameter part having a diameter smaller than that of the medium diameter part formed between the large diameter part and the medium diameter part.

According to a second aspect of the present invention, an outer circumferential portion of a piston band, in a natural state before being disposed in a cylinder, includes a medium diameter part formed on a side close to a distal end portion of a piston rod, a large diameter part having a diameter larger than that of the medium diameter part formed on a side far from the distal end portion, and a small diameter part having a diameter smaller than that of the medium diameter part formed between the large diameter part and the medium diameter part.

### Advantageous Effects of Invention

According to the above-described configuration, it is possible to increase a ratio of increase in frictional force between the piston and the cylinder to an increase in radial force applied to the piston rod.

### BRIEF DESCRIPTION OF DRAWINGS

FIG. 1 is a cross-sectional view illustrating a shock absorber according to one embodiment of the present invention.

FIG. 2A is a cross-sectional view illustrating an outer circumferential portion of a piston of the shock absorber according to one embodiment of the present invention and is a view illustrating a state before being disposed in a cylinder.

FIG. 2B is a cross-sectional view illustrating the outer circumferential portion of the piston of the shock absorber according to one embodiment of the present invention and is a view illustrating a state in which the piston rod after being disposed in the cylinder does not receive a radial force.

FIG. 3A is a cross-sectional view illustrating the outer circumferential portion of the piston of the shock absorber of one embodiment according to the present invention after being disposed in the cylinder and is a view illustrating a state in which a radial force received by the piston rod is small.

FIG. 3B is a cross-sectional view illustrating the outer circumferential portion of the piston of the shock absorber of one embodiment according to the present invention after being disposed in the cylinder and is a view illustrating a state in which a radial force received by the piston rod is large.

FIG. 4 is a characteristics diagram showing a relationship of a frictional coefficient with respect to a surface pressure of polytetrafluoroethylene (PTFE).

FIG. 5 is a characteristics diagram showing a relationship of a frictional force generated between the piston and the cylinder with respect to a radial force (lateral force) applied to the piston rod of the shock absorber or the like of one embodiment according to the present embodiment.

FIG. 6A is a cross-sectional view of a state in which a piston of a shock absorber is disposed in a cylinder and is a view illustrating comparative example 1.

FIG. 6B is a cross-sectional view of a state in which a piston of a shock absorber is disposed in a cylinder and is a view illustrating comparative example 2.

### DESCRIPTION OF EMBODIMENTS

A shock absorber according to one embodiment of the present invention will be described below with reference to the drawings.

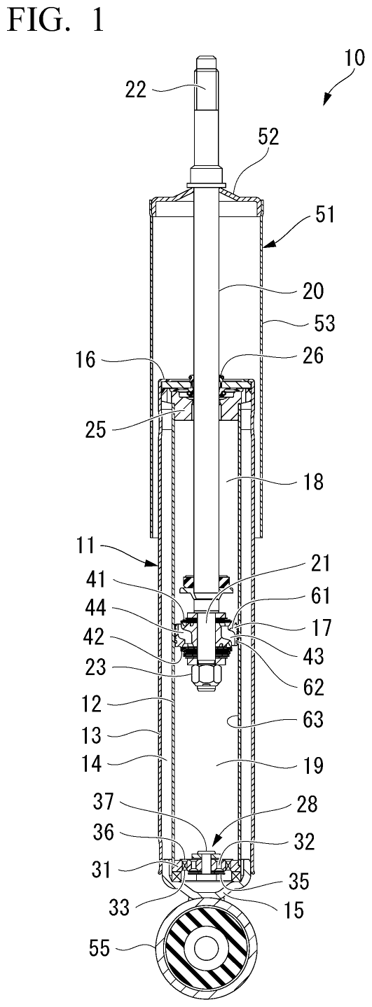

A shock absorber 10 of the present embodiment is a shock absorber used in a suspension device of an automobile or a railway vehicle. As illustrated in FIG. 1, the shock absorber 10 includes a cylinder 11 in which a working fluid is sealed. The cylinder 11 includes a cylindrical inner cylinder 12 and a bottomed cylindrical outer cylinder 13 having a larger diameter than the inner cylinder 12 and provided on an outer side of the inner cylinder 12. A reservoir chamber 14 is formed between the inner cylinder 12 and the outer cylinder 13. The outer cylinder 13 includes a bottom portion 15 on one side in an axial direction and an opening 16 on the other side in the axial direction, and the opening 16 is an opening of the cylinder 11.

A piston 17 is slidably inserted into the inner cylinder 12 of the cylinder 11. The piston 17 partitions the inside of the inner cylinder 12 of the cylinder 11 into one side chamber 18 and the other side chamber 19. In the cylinder 11, a working liquid serving as a working fluid is sealed into the one side chamber 18 and the other side chamber 19, and a working liquid and a gas serving as a working fluid are sealed into the reservoir chamber 14.

A piston rod 20 made of a metal is connected to the piston 17. In the piston rod 20, a base end portion 21 on one side in the axial direction is inserted into the cylinder 11, and a distal end portion 22 on the other side in the axial direction protrudes outward from one axial end of the cylinder 11, that is, one axial end of the inner cylinder 12 and the outer cylinder 13. The piston 17 is fixed to the base end portion 21 of the piston rod 20 using a nut 23. The piston 17 moves integrally with the piston rod 20.

On an inner side of the cylinder 11, an annular rod guide 25 and an annular seal member 26 are disposed on the opening 16 side of the outer cylinder 13 from which the piston rod 20 protrudes, and a base valve 28 is provided on the bottom portion 15 side of the outer cylinder 13. In other words, the rod guide 25 is provided on a side of the cylinder 11 opposite to the bottom portion 15. The rod guide 25 guides movement of the piston rod 20 in the axial direction while restricting movement thereof in a radial direction. The seal member 26 closes the opening 16 side at one end of the cylinder 11 and restricts leakage of the working liquid in the inner cylinder 12 and the gas and the working liquid in the reservoir chamber 14 to the outside.

In a base body 31 of the base valve 28, a liquid passage 32 and a liquid passage 33 that allow the other side chamber 19 and the reservoir chamber 14 to communicate with each other are formed. A disc valve 35 capable of opening and closing the liquid passage 32 on a radially inward side and a disc valve 36 capable of opening and closing the liquid passage 33 on a radially outward side are attached to the base body 31 using a rivet 37.

The disc valve 35 allows a flow of the working liquid through the liquid passage 32 from the other side chamber 19 to the reservoir chamber 14 while restricting a flow thereof from the reservoir chamber 14 to the other side chamber 19. The disc valve 35 is a damping valve that causes the working liquid to flow from the other side chamber 19 to the reservoir chamber 14 to generate a damping force at the time when the piston rod 20 moves to a compression side in which an amount of extension thereof from the cylinder 11 is reduced.

The disc valve 36 allows a flow of the working liquid through the liquid passage 33 from the reservoir chamber 14 to the other side chamber 19 while restricting a flow thereof from the other side chamber 19 to the reservoir chamber 14. The disc valve 36 is a suction valve that causes the working liquid to flow from the reservoir chamber 14 to the other side chamber 19 substantially without generating a damping force when the piston rod 20 moves to an extension side in which an amount of extension thereof from the cylinder 11 is increased.

In the piston rod 20, the above-described piston 17 and disc valves 41 and 42 on both sides thereof are attached to the base end portion 21 on a side inserted into the inner cylinder 12 using the nut 23. A liquid passage 43 and a liquid passage 44 that allow the other side chamber 19 and the one side chamber 18 to communicate with each other are provided in the piston 17. The disc valve 41 is capable of opening and closing the liquid passage 43, and the disc valve 42 is capable of opening and closing the liquid passage 44.

The disc valve 41 allows a flow of the working liquid through the liquid passage 43 from the other side chamber 19 to the one side chamber 18 while restricting a flow thereof from the one side chamber 18 to the other side chamber 19. The disc valve 41 is a damping valve that causes the working liquid to flow from the other side chamber 19 to the one side chamber 18 to generate a damping force at the time when the piston rod 20 moves to the compression side.

The disc valve 42 allows a flow of the working liquid through the liquid passage 44 from the one side chamber 18 to the other side chamber 19 while restricting a flow thereof from the other side chamber 19 to the one side chamber 18. The disc valve 42 is a damping valve that causes the working liquid to flow from the one side chamber 18 to the other side chamber 19 to generate a damping force at the time when the piston rod 20 moves to the extension side.

A cover member 51 is attached to one side of the piston rod 20 extending from the cylinder 11. The cover member 51 includes a disc-shaped annular member 52 fixed to an intermediate portion in the axial direction on one side of the piston rod 20 extending from the cylinder 11, and a cylindrical tubular member 53 joined to an outer circumferential side of the annular member 52 and extending in a direction of the cylinder 11 from the annular member 52. The tubular member 53 overlaps the cylinder 11 in the axial direction and covers an outer circumferential portion of the cylinder 11 and a portion of the piston rod 20 protruding from the seal member 26.

A mounting eye 55 is fixed to an outer side of the bottom portion 15 of the outer cylinder 13.

When the shock absorber 10 is mounted on a vehicle, for example, the piston rod 20 is disposed on an upper side to be connected to a vehicle body side, and the mounting eye 55 is disposed on a lower side to be connected to a wheel side.

When the piston rod 20 moves to the extension side, the piston 17 moves integrally therewith in a direction of reducing a volume of the one side chamber 18 and increasing a volume of the other side chamber 19. Then, the disc valve 42 provided in the piston 17 causes the working liquid to flow from the one side chamber 18 to the other side chamber 19 through the liquid passage 44 to generate a damping force at that time. At this time, the disc valve 36 of the base valve 28 causes the working liquid to flow from the reservoir chamber 14 to the other side chamber 19 substantially without generating a damping force and supplements the working liquid in the other side chamber 19 by a volume corresponding to a protrusion amount of the piston rod 20 from the cylinder 11.

When the piston rod 20 moves to the compression side, the piston 17 moves integrally therewith in a direction of reducing a volume of the other side chamber 19 and increasing a volume of the one side chamber 18. At this time, the disc valve 41 provided in the piston 17 causes the working liquid to flow from the other side chamber 19 to the one side chamber 18 through the liquid passage 43 to generate a damping force at that time. Also, at this time, the disc valve 35 of the base valve 28 causes the working liquid to flow from the other side chamber 19 to the reservoir chamber 14 to generate a damping force at that time.

The piston 17 includes a piston main body 61 that is made of metal and is joined to the base end portion 21 of the piston rod 20, and a piston band 62 made of a synthetic resin that constitutes an outer circumferential portion of the piston 17 by being attached to an outer circumferential portion of the piston main body 61. The piston band 62 constituting the outer circumferential portion of the piston 17 seals a space between the piston 17 and an inner circumferential portion 63 of the inner cylinder 12 of the cylinder 11.

The piston main body 61 has an annular shape and includes the base end portion 21 of the piston rod 20 fitted to an inner circumferential side thereof. The liquid passages 43 and 44 described above are formed in the piston main body 61.

The outer circumferential portion of the piston 17 will be further described.

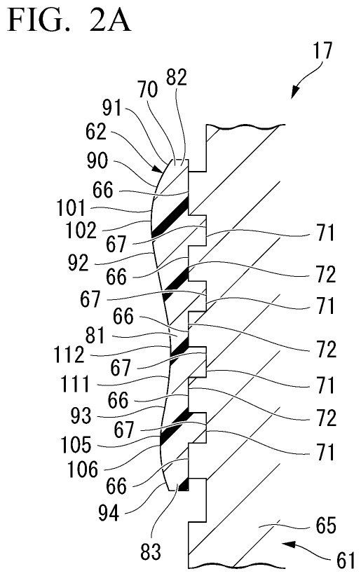

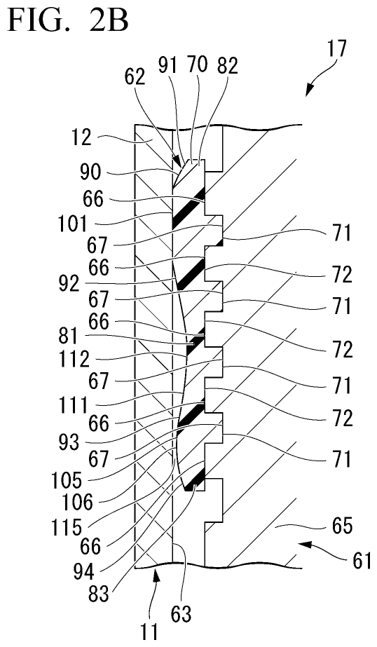

As illustrated in FIG. 2A, the outer circumferential portion of the piston main body 61 includes a cylindrical outer circumferential main body part 65 and an annular fitting protruding part 66 protruding radially outward from the outer circumferential main body part 65. A plurality of fitting protruding parts 66 are disposed at intervals in the axial direction of the piston main body 61. Thereby, an annular fitting groove part 67 is formed between the fitting protruding parts 66 adjacent to each other in the axial direction to be recessed radially inward with respect to outer circumferential surfaces of these fitting protruding parts 66. A plurality of fitting groove parts 67 are also disposed at intervals in the axial direction of the piston main body 61. The plurality of fitting protruding parts 66 are formed to have the same outer diameter, and the plurality of fitting groove parts 67 are also formed to have the same groove bottom diameter.

The piston band 62 is made of a low friction material such as a fluorine resin, specifically, polytetrafluoroethylene (PTFE). The piston band 62 includes an annular strip-shaped band main body part 70 and an annular inner circumferential side protruding part 71 that protrudes radially inward from the band main body part 70. A plurality of inner circumferential side protruding parts 71 are disposed at intervals in the axial direction of the piston band 62. Thereby, an annular inner circumferential side groove part 72 is formed between the inner circumferential side protruding parts 71 adjacent to each other in the axial direction to be recessed radially outward with respect to outer circumferential surfaces of the inner circumferential side protruding parts 71. A plurality of inner circumferential side groove parts 72 are disposed at intervals in the axial direction of the piston band 62. The plurality of inner circumferential side protruding parts 71 are formed to have the same inner diameter, and the plurality of inner circumferential side groove parts 72 are also formed to have the same groove bottom diameter.

In a state in which the piston band 62 is mounted on the piston main body 61, all the inner circumferential side protruding parts 71 are fitted into the corresponding fitting groove parts 67 and in contact with groove bottom portions of the corresponding fitting groove parts 67. Also, in a state in which the piston band 62 is mounted on the piston main body 61, the fitting protruding parts 66 of the piston main body 61 are fitted into the corresponding inner circumferential side groove parts 72 and in contact with groove bottom portions of the inner circumferential side groove parts 72.

Here, as illustrated in FIG. 2A, the piston band 62 that is in a state of being mounted on the piston main body 61 and in a natural state before being disposed in the cylinder 11 will be described.

In the piston band 62, the band main body part 70 thereof includes an intermediate main body part 81 which is at an intermediate portion in the axial direction and in which the inner circumferential side protruding parts 71 and the inner circumferential side groove parts 72 overlap each other, a first extended part 82 at an end portion on one end side, and a second extended part 83 at an end portion on the other end side. The first extended part 82 is disposed on a side close to the distal end portion 22 of the piston rod 20 illustrated in FIG. 1, and the second extended part 83 is disposed on a side far from the distal end portion 22 of the piston rod 20. In other words, the first extended part 82 extends from an end portion of the intermediate main body part 81 on the distal end portion 22 side to the distal end portion 22 side, and the second extended part 83 extends from an end portion of the intermediate main body part 81 on a side opposite to the distal end portion 22 to a side opposite to the distal end portion 22.

The first extended part 82 is in contact with an outer circumferential portion of the fitting protruding part 66 at an end portion of the piston main body 61 on a side closest to the distal end portion 22, and then protrudes to the distal end portion 22 side in the axial direction with respect to the fitting protruding part 66. The first extended part 82 extends to the distal end portion 22 side in the axial direction with respect to the fitting protruding part 66 that is in contact therewith in a substantially tapered shape such that a diameter thereof decreases toward the distal end portion 22. Further, in the present embodiment, although the first extended part 82 is formed in a substantially tapered shape with its outer circumferential surface having a smooth curved surface so that the diameter decreases toward the distal end portion 22, it may be formed as a surface having a cross section in a straight line.

The second extended part 83 is in contact with an outer circumferential portion of the fitting protruding part 66 at an end portion of the piston main body 61 on a side farthest from the distal end portion 22, and then protrudes to a side opposite to the distal end portion 22 in the axial direction with respect to the fitting protruding part 66. The second extended part 83 extends to a side opposite to the distal end portion 22 in the axial direction with respect to the fitting protruding part 66 that is in contact therewith in a substantially tapered shape such that a diameter thereof decreases with distance away from the distal end portion 22. Further, in the present embodiment, although the second extended part 83 is formed in a substantially tapered shape with its outer circumferential surface having a smooth curved surface so that the diameter decreases with distance away from the distal end portion 22, it may be formed as a surface having a cross section in a straight line.

An outer circumferential portion 90 of the band main body part 70, which is an outer circumferential portion of the piston band 62, includes a first outer circumferential surface portion 91 in which a diameter thereof increases with distance away from the distal end portion 22 in the axial direction, a second outer circumferential surface portion 92 in which a diameter thereof decreases with distance away from the distal end portion 22 in the axial direction, a third outer circumferential surface portion 93 in which a diameter thereof increases with distance away from the distal end portion 22 in the axial direction, and a fourth outer circumferential surface portion 94 in which a diameter thereof decreases with distance away from the distal end portion 22 in the axial direction in order from a side closer to the distal end portion 22 of the piston rod 20.

The first outer circumferential surface portion 91, the second outer circumferential surface portion 92, the third outer circumferential surface portion 93, and the fourth outer circumferential surface portion 94 have a smoothly continuous shape without bending.

A boundary side between the first outer circumferential surface portion 91 and the second outer circumferential surface portion 92 constitutes an outer circumferential surface of an annular first bulging part 101 having a shape that bulges radially outward in the piston band 62. At a radially outer portion of the first bulging part 101, a cross section thereof in a plane including a central axis of the piston band 62 has an arc shape having a center on the central axis side of the piston band 62. Further, the radially outer portion of the first bulging part 101 is not limited to an arc shape and may be a rectangular protrusion shape. A boundary position between the first outer circumferential surface portion 91 and the second outer circumferential surface portion 92 is a position of a maximum diameter of the first bulging part 101. This portion is a large diameter part 102 (first protruding part). The first bulging part 101 and the large diameter part 102 are also included in the outer circumferential portion 90 of the piston band 62, and the large diameter part 102 has a maximum outer diameter in the outer circumferential portion 90.

A boundary side between the third outer circumferential surface portion 93 and the fourth outer circumferential surface portion 94 constitutes an outer circumferential surface of an annular second bulging part 105 having a shape that bulges radially outward in the piston band 62. At a radially outer portion of the second bulging part 105, a cross section thereof in a plane including the central axis of the piston band 62 has an arc shape having a center on the central axis side of the piston band 62. Further, the radially outer portion of the second bulging part 105 is not limited to an arc shape and may be a rectangular protrusion shape. A boundary position between the third outer circumferential surface portion 93 and the fourth outer circumferential surface portion 94 is a position of a maximum diameter of the second bulging part 105, and this portion is a medium diameter part 106 (second protruding part). The medium diameter part 106 has a diameter different from that of the large diameter part 102 and has a diameter smaller than that of the large diameter part 102. The second bulging part 105 and the medium diameter part 106 are also included in the outer circumferential portion 90 of the piston band 62. The medium diameter part 106 and the large diameter part 102 are provided to be spaced apart from each other in the axial direction.

A boundary side between the second outer circumferential surface portion 92 and the third outer circumferential surface portion 93 constitutes an outer circumferential surface of an annular recessed part 111 having a shape that is recessed radially inward in the piston band 62. At a radially outer portion of the recessed part 111, a cross section thereof in a plane including the central axis of the piston band 62 has an arc shape having a center on a side opposite to the central axis of the piston band 62. A boundary position between the second outer circumferential surface portion 92 and the third outer circumferential surface portion 93 is a position of a minimum diameter of the recessed part 111, and this portion is a small diameter part 112 (minimum diameter part). The small diameter part 112 has a diameter different from those of the large diameter part 102 and the medium diameter part 106 and has a diameter smaller than that of the medium diameter part 106. The recessed part 111 and the small diameter part 112 are also included in the outer circumferential portion 90 of the piston band 62, and the small diameter part 112 has a minimum outer diameter in the outer circumferential portion 90. The large diameter part 102 and the medium diameter part 106 are provided to protrude radially outward with respect to the small diameter part 112. The small diameter part 112 is provided to be spaced apart from the medium diameter part 106 and the large diameter part 102 in the axial direction. Further, in the present embodiment, although the second outer circumferential surface portion 92 and the third outer circumferential surface portion 93 on both sides in the axial direction of the small diameter part 112 are formed as curved surfaces that continuously increase in diameter from the small diameter part 112, line segments connecting the small diameter part 112 to the second outer circumferential surface portion 92 and the third outer circumferential surface portion 93 may be formed to have a cross section in a straight line. For example, the small diameter part 112 having a cylindrical surface shape may be formed between the second outer circumferential surface portion 92 and the third outer circumferential surface portion 93. Alternatively, the small diameter part 112 having a tapered surface shape may be formed between the second outer circumferential surface portion 92 and the third outer circumferential surface portion 93.

As described above, the outer circumferential portion 90 of the piston band 62 includes the first bulging part 101, the recessed part 111, and the second bulging part 105 in order from a side closer to the distal end portion 22 of the piston rod 20. Also, on the outer circumferential portion 90 of the piston band 62, the large diameter part 102 is formed on a side close to the distal end portion 22 of the piston rod 20, a medium diameter part 106 having a diameter smaller than that of the large diameter part 102 is formed on a side far from the distal end portion 22, and a small diameter part 112 having a diameter smaller than that of the medium diameter part 106 is formed between the large diameter part 102 and the medium diameter part 106 in a natural state before being disposed in the cylinder 11. In this natural state, an outer diameter of the large diameter part 102 is larger than an inner diameter of the inner cylinder 12 of the cylinder 11, and an outer diameter of the medium diameter part 106 is smaller than the inner diameter of the inner cylinder 12 of the cylinder 11. Therefore, an outer diameter of the small diameter part 112 is also smaller than the inner diameter of the inner cylinder 12 of the cylinder 11. The piston band 62 made of a synthetic resin is formed into the above-described shape by controlling a temperature at the time of formation and a period of time for formation.

When the piston 17 constituted by the piston main body 61 and the piston band 62 described above is fitted into the inner circumferential portion 63 of the inner cylinder 12 made of a metal, the first extended part 82 is disposed on the rod guide 25 side, and the second extended part 83 is disposed on the bottom portion 15 side of the cylinder 11. In this state, since the outer diameter of the large diameter part 102 is larger than the inner diameter of the inner cylinder 12 of the cylinder 11, the first bulging part 101 including the large diameter part 102 elastically deforms inward in the radial direction as illustrated in FIG. 2B, and thereby the piston band 62 comes into close contact with the cylindrical inner circumferential portion 63 of the inner cylinder 12. At this time, since the outer diameter of the medium diameter part 106 is smaller than the inner diameter of the inner cylinder 12 of the cylinder 11, unless an external force in the radial direction, a so-called lateral force is applied to the piston rod 20, the piston band 62 has a gap 115 between itself and the inner circumferential portion 63 of the inner cylinder 12 without the second bulging part 105 including the medium diameter part 106 coming into contact with the inner circumferential portion 63 of the inner cylinder 12. At this time, the recessed part 111 including the small diameter part 112 also has a gap between itself and the inner circumferential portion 63 of the inner cylinder 12. Further, it is preferable that the piston band 62 have the gap 115 between itself and the inner circumferential portion 63 of the inner cylinder 12 without the second bulging part 105 including the medium diameter part 106 coming into contact with the inner circumferential portion 63 of the inner cylinder 12, but a case of being in slight contact therewith in a state in which a lateral force is not applied may also be included therein.

In the shock absorber 10 including the piston 17 disposed in the inner cylinder 12 of the cylinder 11 as described above, the piston 17 moves with respect to the cylinder 11 together with the piston rod 20.

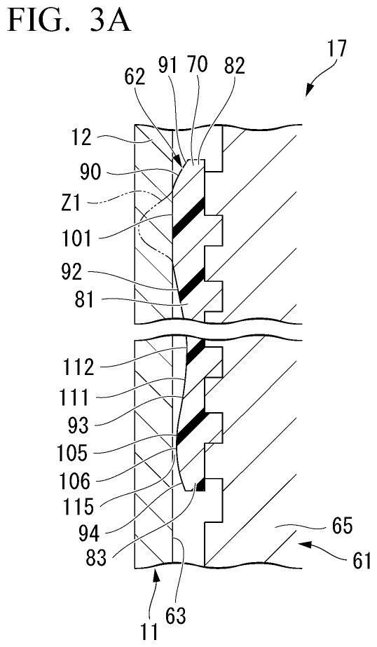

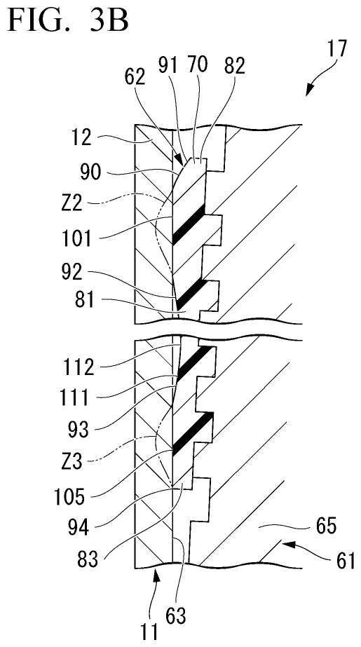

At that time, when a lateral force received by the piston rod 20 is less than a first predetermined value including zero, even when the piston rod 20 tilts with respect to the cylinder 11 with the rod guide 25 as a fulcrum, the piston 17 comes into contact with the inner circumferential portion 63 of the inner cylinder 12 only via the first bulging part 101 including the large diameter part 102 as illustrated in FIG. 3A and moves in the axial direction. A surface pressure distribution at this time is as illustrated by the double dot-dashed line Z1 in FIG. 3A.

Also, when the piston rod 20 receives a lateral force equal to or more than the first predetermined value and less than a second predetermined value, an amount of tilting by which the piston rod 20 tilts with respect to the cylinder 11 with the rod guide 25 as a fulcrum becomes larger than that described above, and the piston 17 comes into contact with the inner circumferential portion 63 of the inner cylinder 12 via the first bulging part 101 including the large diameter part 102 and the second bulging part 105 including the medium diameter part 106 as illustrated in FIG. 3B, and moves in the axial direction. At this time, the small diameter part 112 of the recessed part 111 is not in contact with the inner circumferential portion 63 of the inner cylinder 12. A contact area of the piston band 62 with the inner circumferential portion 63 at this time is large compared to that in the above-described state in which only the first bulging part 101 comes into contact therewith, and thereby a surface pressure decreases. A surface pressure distribution at this time is as illustrated by the double dot-dashed line Z2 and Z3 in FIG. 3B, and the surface pressure becomes lower than in the case illustrated by the double dot-dashed line Z1 in FIG. 3A. That is, the contact area between the piston band 62 and the inner circumferential portion 63 of the cylinder 11 when a radial force acts on the piston rod 20 becomes large compared to that when a radial force does not act on the piston rod 20.

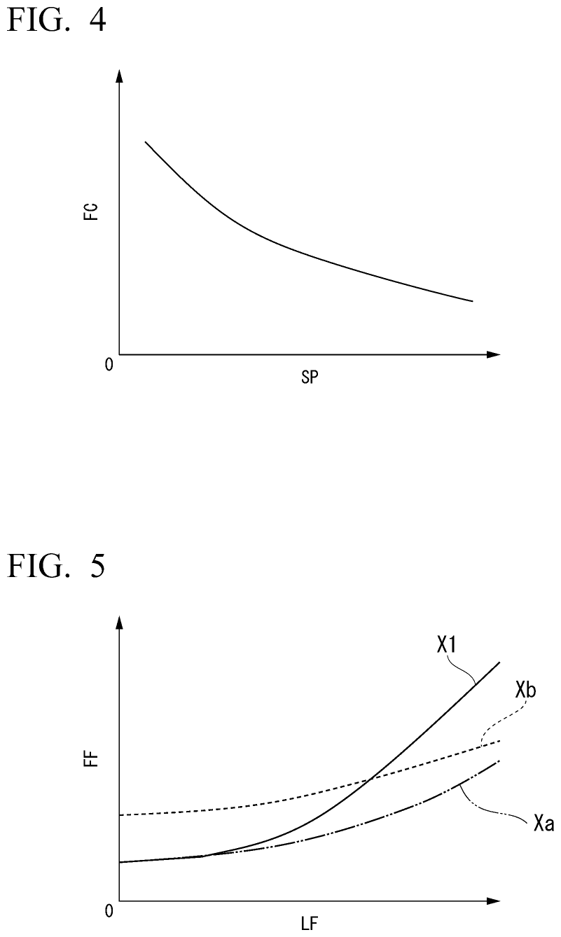

FIG. 4 is a characteristics diagram showing a relationship of a frictional coefficient with respect to a surface pressure of polytetrafluoroethylene (PTFE). FIG. 5 is a characteristics diagram showing a relationship of a frictional force generated between the piston and the cylinder with respect to a radial force (lateral force) applied to the piston rod of the shock absorber or the like according to the present embodiment. In FIG. 4, the vertical axis represents a frictional coefficient (FC) and the horizontal axis represents a surface pressure (SP). In FIG. 5, the vertical axis represents a frictional force (FF) and the horizontal axis represents a lateral force (LF).

As illustrated in FIG. 4, PTFE is a material having surface pressure dependence in which a frictional coefficient is low when a surface pressure is high, and the frictional coefficient is high when the surface pressure is low. Therefore, since the piston band 62 made of PTFE has a higher frictional coefficient when a surface pressure becomes lower, a frictional force generated on a contact surface between the piston 17 and the cylinder 11 increases as shown by the solid line X1 in FIG. 5 compared to the case in which the piston 17 comes into contact with the inner circumferential portion 63 of the inner cylinder 12 only via the first bulging part 101 and a lateral force thereof is small.

Further, when the piston rod 20 receives a lateral force equal to or larger than a second predetermined value, an amount of tilting by which the piston rod 20 tilts with respect to the cylinder 11 with the rod guide 25 as a fulcrum becomes even larger than the above, and the piston 17 comes into contact with the inner circumferential portion 63 of the inner cylinder 12 via the first bulging part 101, the second bulging part 105, and the recessed part 111, and moves in the axial direction. A contact area of the piston band 62 with the inner circumferential portion 63 at this time is large compared to that in the above-described state in which only the first bulging part 101 and the second bulging part 105 come into contact therewith, and thereby the surface pressure decreases. Since the piston band 62 has a higher frictional coefficient when the surface pressure becomes lower, a frictional force generated on the contact surface between the piston 17 and the cylinder 11 further increases as shown by the solid line X1 in FIG. 5 compared to the case in which the piston 17 comes into contact with the inner circumferential portion 63 of the inner cylinder 12 only via the first bulging part 101 and the second bulging part 105.

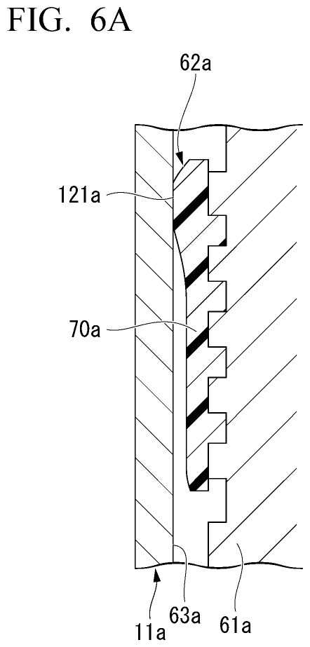

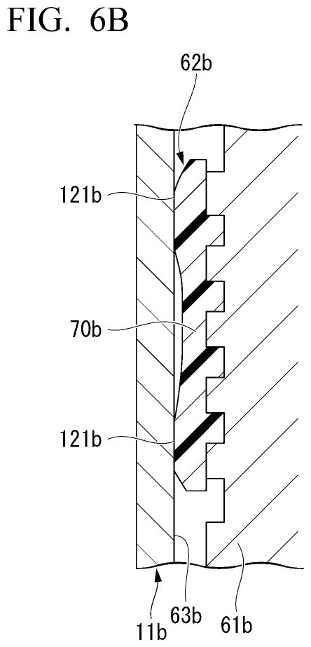

As illustrated in FIG. 6A, the above-described Patent Literature 1 describes that a piston band 62a mounted on an outer circumferential portion of a piston main body 61a includes an annular protruding part 121a that bulges radially outward with respect to a band main body part 70a only at one end side (on a rod guide side that is not illustrated) of the piston band 62a. When such a structure is referred to as comparative example 1, in comparative example 1, in a state in which a lateral force received by the piston rod is small including zero, since the annular protruding part 121a on one side of the piston band 62a comes into sliding contact with an inner circumferential portion 63a of a cylinder 11a at a high surface pressure, a frictional force generated by the piston band 62a can be reduced to be small as illustrated by a double dot-dashed line Xa in FIG. 5. From this state, when the lateral force increases and becomes relatively large, the other end portion of the piston band 62a also comes into sliding contact with the inner circumferential portion of the cylinder 11a in addition to the annular protruding part 121a, and thereby the frictional force generated by the piston band 62a increases. At this time, when the lateral force does not become relatively large, since the other end portion of the piston band 62a does not come into sliding contact with the inner circumferential portion 63a of the cylinder 11a, a ratio of increase in the frictional force of the piston band 62a to an increase in the lateral force is small.

Also, as illustrated in FIG. 6B, Patent Literature 1 describes that a piston band 62b mounted on an outer circumferential portion of a piston main body 61b includes annular protruding parts 121b having the same outer diameter and bulging radially outward from a band main body part 70b which are provided at both end portions of the piston band 62b. When such a structure is referred to as comparative example 2, in comparative example 2, as illustrated in FIG. 6B, even in a state in which a lateral force received by the piston rod is small including zero, since the annular protruding parts 121b on both sides of the piston band 62b come into sliding contact with an inner circumferential portion 63b of a cylinder 11b, a surface pressure thereof is low and a frictional force generated by the piston band 62b is large even in a state in which the lateral force is small including zero, as illustrated by the dashed line Xb in FIG. 5. When the lateral force increases from this state, although the frictional force generated by the piston band 62b further increases, a ratio of the increase is low because the annular protruding parts 121b on both sides are in sliding contact with the inner circumferential portion 63b of the cylinder 11b from the beginning.

In contrast to these, in the present embodiment, on the outer circumferential portion 90 of the piston band 62, the large diameter part 102 is formed on a side close to the distal end portion 22 of the piston rod 20, the medium diameter part 106 having a diameter smaller than that of the large diameter part 102 is formed on a side far from the distal end portion 22, and the small diameter part 112 having a diameter smaller than that of the medium diameter part 106 is formed between the large diameter part 102 and the medium diameter part 106 in a natural state before being disposed in the cylinder 11. Therefore, in a state in which a lateral force received by the piston rod 20 is small including zero, the first bulging part 101 including the large diameter part 102 can come into contact with the inner circumferential portion 63 of the inner cylinder 12, and when the lateral force becomes larger than this, the first bulging part 101 including the large diameter part 102 and the second bulging part 105 including the medium diameter part 106 can come into contact with the inner circumferential portion 63 of the inner cylinder 12. Further, when the lateral force becomes larger than this, a contact area of the piston band 62 with the inner circumferential portion 63 of the inner cylinder 12 can be increased by an amount of a contact area of the recessed part 111 in addition to the first bulging part 101 including the large diameter part 102 and the second bulging part 105 including the medium diameter part 106.

Therefore, as shown by the solid line X1 in FIG. 5, frictional characteristics in which a frictional force generated by the piston band 62 when the lateral force is small is made to be small, and a frictional force generated by the piston band 62 increases when the lateral force increases and a ratio of the increase at that time is high can be obtained. Therefore, an axial force of the piston rod 20 when the lateral force is small can be reduced to be small, and an axial force of the piston rod 20 can be increased when the lateral force increases.

Also, since the medium diameter part 106 of the piston band 62 has a gap 115 between itself and the inner circumferential portion 63 of the cylinder 11 in a state in which the piston rod 20 does not receive a radial force, the frictional characteristics in which the frictional force generated by the piston band 62 when the lateral force is small is made to be small, and the frictional force generated by the piston band 62 increases when the lateral force increases and a ratio of the increase at that time is high is more prominent. Further, when the frictional force between the medium diameter part 106 and the cylinder 11 with the piston rod 20 receiving no radial force is small, the medium diameter part 106 may come into contact with the inner circumferential portion 63 of the cylinder 11 without the gap 115 therebetween.

Also, the piston band 62 is formed of a low friction material having a characteristic in which a frictional coefficient increases when a surface pressure decreases. Therefore, the frictional characteristics in which a frictional force when the lateral force is small, the contact area with the cylinder 11 is small, and the surface pressure is high is made to be small, and a frictional force increases when the lateral force increases, the contact area with the cylinder 11 increases, and the surface pressure decreases and a ratio of the increase at that time is high becomes more prominent.

Here, a frictional force characteristic generated by a shock absorber is important for creating a stable vehicle posture when a vehicle turns. Particularly, an axial force of a shock absorber in a low speed region of a piston is important, but in this region, a contribution of a frictional force generated between a piston band and a cylinder is high. When the frictional force generated between the piston band and the cylinder is small, a ride comfort performance can be improved, but the vehicle tends to be unstable when the vehicle turns.

On the other hand, when the shock absorber 10 of the present embodiment is used for a suspension device of a vehicle, as described above, since the frictional force generated by the piston band 62 can be reduced during normal traveling in which a lateral force is small, satisfactory ride comfort can be obtained. That is, in a situation in which a lateral force applied to the shock absorber 10 is small, such as, when traveling in a straight line, since the frictional force of the shock absorber 10 can be reduced by bringing only the first bulging part 101 of the piston band 62 on the rod guide 25 side into contact with the cylinder 11, it is possible to improve a ride comfort performance

Also, when the vehicle turns during which a lateral force is large, since the frictional force generated by the piston band 62 can be increased, a posture of the vehicle is stabilized. That is, in a situation in which a lateral force applied to the shock absorber 10 is large during turning or the like, a frictional force of the shock absorber 10 can be increased by bringing the second bulging part 105 of the cylinder 11 on the bottom portion 15 side into contact with the cylinder 11 in addition to the first bulging part 101 of the piston band 62 on the rod guide 25 side, and when the lateral force further increases, the frictional force of the shock absorber 10 can be increased by bringing the recessed part 111 between them into contact with the cylinder 11, and thereby steering stability can be improved. Therefore, improvement in ride comfort performance and improvement in steering stability can be achieved at the same time.

Further, in the embodiment described above, on the outer circumferential portion 90 of the piston band 62, the large diameter part 102 is formed on a side close to the distal end portion 22 of the piston rod 20, the medium diameter part 106 having a diameter smaller than that of the large diameter part 102 is formed on a side far from the distal end portion 22 of the piston rod 20, and the small diameter part 112 having a diameter smaller than that of the medium diameter part 106 is formed between the large diameter part 102 and the medium diameter part 106, but the above described piston rod 62 may be vertically turned over and configured such that the large diameter part 102 is formed on a side far from the distal end portion 22 of the piston rod 20, the medium diameter part 106 is formed on a side close to the distal end portion 22 of the piston rod 20, and the small diameter part 112 having a diameter smaller than that of the medium diameter part 106 is formed between the large diameter part 102 and the medium diameter part 106.

Also, in the above-described embodiment, the large diameter part 102, the medium diameter part 106, and the small diameter part 112 are configured to be formed to have a fixed diameter over the entire circumference of the outer circumferential portion 90 of the piston band 62, but at least one of the large diameter part 102 and the medium diameter part 106 may be formed to partially protrude with respect to the small diameter part 112 in a circumferential direction. Also, although productivity may be deteriorated, it may also be possible to form portions having different diameters in three or more steps partially in the circumferential direction. In any case, a contact area between the piston band 62 and the inner circumferential portion 63 of the cylinder 11 increases when a radial force acts on the piston rod 20 compared to that when a radial force does not act on the piston rod 20.

According to a first aspect of the embodiment described above, a shock absorber includes a bottomed cylindrical cylinder in which a working fluid is sealed, a piston rod having a base end portion inserted into the cylinder and a distal end portion protruding outward from the cylinder, a piston fixed to the base end portion side of the piston rod and partitioning the inside of the cylinder into one side chamber and the other side chamber, and a rod guide provided on a side of the cylinder opposite to a bottom portion to guide the piston rod. An outer circumferential portion of the piston is constituted by a piston band that seals between itself and an inner circumferential portion of the cylinder. An outer circumferential portion of the piston band, in a natural state before being disposed in the cylinder, includes a large diameter part formed on a side close to the distal end portion of the piston rod, a medium diameter part having a diameter smaller than that of the large diameter part formed on a side far from the distal end portion, and a small diameter part having a diameter smaller than that of the medium diameter part formed between the large diameter part and the medium diameter part. Thereby, it is possible to increase a ratio of increase in frictional force between the piston and the cylinder to an increase in radial force applied to the piston rod.

According to a second aspect, a shock absorber includes a bottomed cylindrical cylinder in which a working fluid is sealed, a piston rod having a base end portion inserted into the cylinder and a distal end portion protruding outward from the cylinder, a piston fixed to the base end portion side of the piston rod and partitioning the inside of the cylinder into one side chamber and the other side chamber, and a rod guide provided on a side of the cylinder opposite to a bottom portion to guide the piston rod. An outer circumferential portion of the piston is constituted by a piston band that seals between itself and an inner circumferential portion of the cylinder. An outer circumferential portion of the piston band, in a natural state before being disposed in the cylinder, includes a medium diameter part formed on a side close to the distal end portion of the piston rod, a large diameter part having a diameter larger than that of the medium diameter part formed on a side far from the distal end portion, and a small diameter part having a diameter smaller than that of the medium diameter part formed between the large diameter part and the medium diameter part. Thereby, it is possible to increase a ratio of increase in frictional force between the piston and the cylinder to an increase in radial force applied to the piston rod.

According to a third aspect, in the first or second aspect, the medium diameter part has a gap between itself and the cylinder in a state in which the piston rod does not receive a radial force.

According to a fourth aspect, in any one of the first to third aspects, the piston band is formed of a low friction material having a characteristic in which a frictional coefficient increases when a surface pressure decreases.

According to a fifth aspect, a shock absorber includes a bottomed cylindrical cylinder in which a working fluid is sealed, a piston rod having a base end portion inserted into the cylinder and a distal end portion protruding outward from the cylinder, a piston fixed to the base end portion side of the piston rod and partitioning the inside of the cylinder into one side chamber and the other side chamber, and a rod guide provided on a side of the cylinder opposite to a bottom portion to guide the piston rod. An outer circumferential portion of the piston is constituted by a piston band that seals between itself and an inner circumferential portion of the cylinder. A minimum diameter part, and a first protruding part and a second protruding part provided to protrude with respect to the minimum diameter part are formed on an outer circumferential portion of the piston band in a natural state before being disposed in the cylinder, and the first protruding part and the second protruding part have different diameters and are provided to be spaced apart from each other. Thereby, it is possible to increase a ratio of increase in frictional force between the piston and the cylinder to an increase in radial force applied to the piston rod.

According to a sixth aspect, in the fifth aspect, a contact area between the piston band and the inner circumferential portion of the cylinder increases when a radial force acts on the piston rod compared to that when a radial force does not act on the piston rod.

### INDUSTRIAL APPLICABILITY

According to the shock absorber described above, it is possible to increase a ratio of increase in frictional force between the piston and the cylinder to an increase in radial force applied to the piston rod.

### REFERENCE SIGNS LIST

10 Shock absorber
11 Cylinder
18 One side chamber
19 The other side chamber
20 Piston rod
21 Base end portion
22 Distal end portion
25 Rod guide
62 Piston band
102 Large diameter part (first protruding part)
106 Medium diameter part (second protruding part)
112 Small diameter part (minimum diameter part)
115 Gap

1. A shock absorber comprising:
a bottomed cylindrical cylinder in which a working fluid is sealed;
a piston rod including a base end portion inserted into the cylinder and a distal end portion protruding outward from the cylinder;
a piston fixed to the base end portion side of the piston rod and partitioning the inside of the cylinder into one side chamber and the other side chamber, the piston having fitting protruding parts and fitting groove parts that are alternatively provided on an outer circumferential surface thereof; and
a rod guide provided on a side of the cylinder opposite to a bottom portion to guide the piston rod, wherein
an outer circumferential portion of the piston is constituted by a piston band which seals between the outer circumferential portion of the piston and an inner circumferential portion of the cylinder, and
an outer circumferential portion of the piston band, in a natural state before being disposed in the cylinder, includes:
a large diameter part formed on a side close to the distal end portion of the piston rod and on a position facing the fitting protruding parts;
a medium diameter part having a diameter smaller than that of the large diameter part formed on a side far from the distal end portion; and
a small diameter part having a diameter smaller than that of the medium diameter part formed between the large diameter part and the medium diameter part.

2. A shock absorber comprising:
a bottomed cylindrical cylinder in which a working fluid is sealed;
a piston rod including a base end portion inserted into the cylinder and a distal end portion protruding outward from the cylinder;
a piston fixed to the base end portion side of the piston rod and partitioning the inside of the cylinder into one side chamber and the other side chamber, the piston having fitting protruding parts and fitting groove parts that are alternatively provided on an outer circumferential surface thereof; and
a rod guide provided on a side of the cylinder opposite to a bottom portion to guide the piston rod, wherein
an outer circumferential portion of the piston is constituted by a piston band which seals between the outer circumferential portion of the piston and an inner circumferential portion of the cylinder, and
an outer circumferential portion of the piston band, in a natural state before being disposed in the cylinder, includes:
a medium diameter part formed on a side close to the distal end portion of the piston rod;
a large diameter part having a diameter larger than that of the medium diameter part formed on a side far from the distal end portion and on a position facing the fitting protruding parts; and
a small diameter part having a diameter smaller than that of the medium diameter part formed between the large diameter part and the medium diameter part.

3. The shock absorber according to claim 1, wherein the medium diameter part has a gap between the medium diameter part and the cylinder in a state in which the piston rod does not receive a radial force.

4. The shock absorber according to claim 1, wherein the piston band is formed of a low friction material having a characteristic in which a frictional coefficient increases when a surface pressure decreases.

5. A shock absorber comprising:
a bottomed cylindrical cylinder in which a working fluid is sealed;
a piston rod including a base end portion inserted into the cylinder and a distal end portion protruding outward from the cylinder;
a piston fixed to the base end portion side of the piston rod and partitioning the inside of the cylinder into one side chamber and the other side chamber, the piston having fitting protruding parts and fitting groove parts that are alternatively provided on an outer circumferential surface thereof; and
a rod guide provided on a side of the cylinder opposite to a bottom portion to guide the piston rod, wherein
an outer circumferential portion of the piston is constituted by a piston band which seals between the outer circumferential portion of the piston and an inner circumferential portion of the cylinder,
a minimum diameter part, and a first protruding part and a second protruding part provided to protrude with respect to the minimum diameter part are formed on an outer circumferential portion of the piston band in a natural state before being disposed in the cylinder,
the first protruding part and the second protruding part have different diameters and are provided to be spaced apart from each other, and
the first protruding part is provided on a position that faces the fitting protruding parts.

6. The shock absorber according to claim 5, wherein a contact area between the piston band and the inner circumferential portion of the cylinder increases when a radial force acts on the piston rod compared to that when a radial force does not act on the piston rod.

7. The shock absorber according to claim 2, wherein the piston band is formed of a low friction material having a characteristic in which a frictional coefficient increases when a surface pressure decreases.

8. The shock absorber according to claim 3, wherein the piston band is formed of a low friction material having a characteristic in which a frictional coefficient increases when a surface pressure decreases.
